(19) United States
(12) Patent Application Publication
(10) Pub. No.: US 2019/0009595 A1
(43) Pub. Date: Jan. 10, 2019

(54) CONTROL APPARATUS, CONTROL METHOD THEREOF, STORAGE MEDIUM, AND IMAGE FORMING APPARATUS

(71) Applicant: CANON KABUSHIKI KAISHA, Tokyo (JP)

(72) Inventors: Nobuhiro Kawamura, Nagareyama-shi (JP); Yuzo Harano, Sagamihara-shi (JP); Hideaki Ooba, Yokohama-shi (JP); Aya Ito, Tokyo (JP); Junichi Yamakawa, Kashiwa-shi (JP); Yusuke Kimura, Abiko-shi (JP)

(21) Appl. No.: 16/027,738

(22) Filed: Jul. 5, 2018

(30) Foreign Application Priority Data
Jul. 7, 2017 (JP) 2017-133985

(51) Int. Cl. B41J 29/38; H04N 1/00

(52) U.S. Cl. CPC B41J 29/38; H04N 1/00925

(57) ABSTRACT

A control apparatus accepts one or more job reservations for an image forming apparatus, and makes settings on a plurality of setting items for each paper type of paper used by the image forming apparatus so as to form an image thereon. In a case where selecting a paper type for which settings are made, the control apparatus determines whether or not there is a job that uses a paper of the selected paper type in the accepted jobs. In a case where it is determined that there is a job that uses a paper of the selected paper type in the accepted jobs, the control apparatus performs control on the selected paper type so as to impose a setting restriction to a portion of the plurality of setting items, and allow settings to be made on another setting items.

### BACKGROUND OF THE INVENTION

### Field of the Invention

The present invention relates to a control apparatus, a control method thereof, a storage medium, and an image forming apparatus.

### Description of the Related Art

In an image forming apparatus such as a multifunction peripheral, various types of settings can be made for each paper for use in printing. Examples of settings include set values set for each paper such as paper name, size, grammage and surface nature, and set values that are influenced by the characteristic properties of the multifunction peripheral when printing is performed on paper. The set values that are influenced by the characteristic properties of the multifunction peripheral are, for example, the amount of adjustment of registration position on the front/back side of paper, and the amount of curling correction of paper. An operator who uses the multifunction peripheral sets these set values to be optimal for printing to obtain a printed matter.

On the other hand, in a multifunction peripheral that has a job reservation function, if a change is made to the paper size or paper type that has been set for a reserved job before the reserved job is executed, the reserved job may not be executed, or the resulting printed matter may be inappropriate. To address this, Japanese Patent Laid-Open No. 2008-221469 proposes a technique that prohibits a change to the paper settings of a sheet feeding stage that is to be used for a reserved job until the reserved job finishes printing.

However, the conventional technique described above has the following problem. For example, in a multifunction peripheral for commercial printing, it is often the case that print jobs that need to be processed in one day are reserved, and the print jobs are printed after an operator who knows the amount of paper used in one day adjusts the set values of the paper to be optimal. In this case, because a change cannot be made to the settings of the paper to be used for the reserved jobs, the multifunction peripheral is inconvenient and non-user friendly.

### SUMMARY OF THE INVENTION

The present invention enables realization of a mechanism that allows, after a job has been reserved, various types of adjustments appropriate for paper to be used by the reserved job to be made.

One aspect of the present invention provides a control apparatus that controls an image forming apparatus, the control apparatus comprising: a memory device that stores a set of instructions; and at least one processor that executes the set of instructions to: accept one or more job reservations for the image forming apparatus; make settings on a plurality of setting items for each paper type of paper used by the image forming apparatus so as to form an image thereon; in a case where a paper type is selected via the settings, determine whether or not there is a job that uses a paper of the selected paper type in the accepted jobs; and in a case where it is determined that there is a job that uses a paper of the selected paper type in the accepted jobs, perform control on the selected paper type so as to impose a setting restriction to a portion of the plurality of setting items, and allow settings to be made on another setting items.

Another aspect of the present invention provides a control method of controlling a control apparatus that controls an image forming apparatus, the method comprising: accepting one or more job reservations for the image forming apparatus; making settings on a plurality of setting items for each paper type of paper used by the image forming apparatus so as to form an image thereon; in a case where selecting a paper type for which settings are made via a setting unit, determining whether or not there is a job that uses a paper of the selected paper type in the accepted jobs; and in a case where it is determined in the determining that there is a job that uses a paper of the selected paper type in the jobs accepted in the accepting, performing control on the selected paper type so as to impose a setting restriction to a portion of the plurality of setting items, and allow settings to be made on another setting items.

Still another aspect of the present invention provides a non-transitory computer-readable storage medium storing a computer program for causing a computer to execute a control method of controlling a control apparatus that controls an image forming apparatus, the method comprising: accepting one or more job reservations for the image forming apparatus; making settings on a plurality of setting items for each paper type of paper used by the image forming apparatus so as to form an image thereon; in a case where selecting a paper type for which settings are made via a setting unit, determining whether or not there is a job that uses a paper of the selected paper type in the accepted jobs; and in a case where it is determined in the determining that there is a job that uses a paper of the selected paper type in the jobs accepted in the accepting, performing control on the selected paper type so as to impose a setting restriction to a portion of the plurality of setting items, and allow settings to be made on another setting items.

Yet still another aspect of the present invention provides an image forming apparatus comprising: a memory device that stores a set of instructions; and at least one processor that executes the set of instructions to: accept one or more job reservations; make settings on a plurality of setting items for each paper type of paper used so as to form an image thereon; in a case where a paper type is selected via the settings, determine whether or not there is a job that uses a paper of the selected paper type in the accepted jobs; and in a case where it is determined that there is a job that uses a paper of the selected paper type in the accepted jobs, perform control on the selected paper type so as to impose a setting restriction to a portion of the plurality of setting items, and allow settings to be made on another setting items.

Further features of the present invention will be apparent from the following description of exemplary embodiments with reference to the attached drawings.

### BRIEF DESCRIPTION OF THE DRAWINGS

FIG. 1 is a block diagram showing an example of configuration of an image forming system according to one embodiment.

FIG. 2 is a block diagram showing a hardware configuration of an image forming apparatus 103 according to one embodiment.

FIG. 3 is a block diagram showing a hardware configuration of a control apparatus 102 according to one embodiment.

FIGS. 4A and 4B are diagrams showing an example of a top screen of a paper management application according to one embodiment.

FIG. 5 is a flowchart performed when the paper management application according to one embodiment is activated.

FIG. 6 is a flowchart performed when the image forming apparatus 103 according to one embodiment is activated.

FIG. 7 is a diagram showing an example of a setting screen for a sheet feeding stage displayed by the paper management application according to one embodiment.

FIG. 8 is a diagram showing an example of an adjustment screen for secondary transfer voltage adjustment according to one embodiment.

FIG. 9 is a diagram showing an example of a sheet feeding stage screen for test print according to one embodiment.

FIG. 10 is a flowchart according to one embodiment.

FIG. 11 is a diagram showing an example of a paper list screen according to one embodiment.

FIG. 12 is a diagram showing an example of a job manager according to one embodiment.

FIG. 13 is a diagram showing an example of a paper edit screen according to one embodiment.

FIG. 14 is a diagram showing an example of a paper edit screen according to one embodiment.

FIG. 15 is a flowchart according to one embodiment.

FIG. 16 is a diagram showing an example of a job manager according to one embodiment.

FIG. 17 is a diagram showing an example of a paper edit screen according to one embodiment.

FIG. 18 is a flowchart according to one embodiment.

FIG. 19 is a diagram showing an example of a job manager according to one embodiment.

FIG. 20 is a diagram showing an example of a paper edit screen according to one embodiment.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

System Configuration

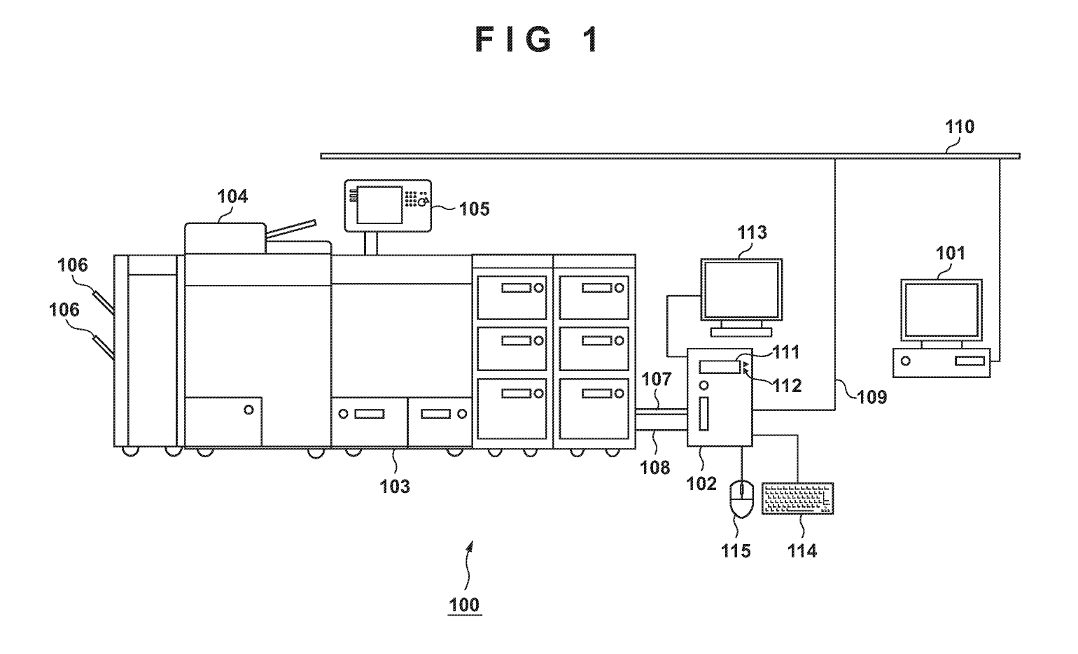

Hereinafter, a configuration, control, and the like that are common to the embodiments according to the present invention will be described. First, an overall configuration of an image forming system 100 will be described with reference to FIG. 1. The image forming system 100 shown in FIG. 1 includes an image forming apparatus 103 and a control apparatus 102. The image forming system 100 is connected to a client computer 101 so as to be capable of communication with the client computer 101. The client computer 101 and the control apparatus 102 are connected so as to be capable of communication via a local area network (LAN) 110 using an Ethernet® cable 109. Also, the control apparatus 102 and the image forming apparatus 103 are connected via an image video cable 107 and a control cable 108. In the present embodiment, the image forming apparatus 103 is not directly connected to the LAN 110. The image forming apparatus 103 and the client computer 101 perform communication with each other via the control apparatus 102. That is, the control apparatus 102 has a function of accepting a job for the image forming apparatus 103, and storing the job. The image forming apparatus 103 may be connected to the LAN 110. That is, the image forming apparatus 103 may be directly connected to the client computer 101 so as to be capable of communication.

The client computer 101 activates an application, and provides a print instruction or the like to the image forming system 100. The control apparatus 102 performs image processing in cooperation with the image forming apparatus 103. The image forming apparatus 103 is a multifunction peripheral that has various types of functions, and is capable of not only performing image processing on image data transmitted from the client computer 101 and the control apparatus 102, but also copying data read from a scanner portion 104 and transmitting data to a shared folder. To scan an image with the scanner portion 104, an operation portion 105 accepts an instruction from the user via any of the keys. Also, the operation portion 105 displays various types of information such as scanning status on a panel.

Paper discharge portions 106 receive paper on which an image has been formed, and discharge the received paper. Reference numeral 111 denotes a display portion of the control apparatus 102, and displays information regarding the control apparatus 102. Reference numeral 112 denotes a hardware operation button portion of the control apparatus 102, and information displayed on the display portion 111 is operated through operation of any of the buttons. The information displayed on the display portion 111 is minimum information (power supply operation, IP address confirmation, or the like) required to operate the control apparatus 102. Reference numeral 113 denotes an external display apparatus of the control apparatus 102, and can be an apparatus such as a liquid crystal monitor or the like. Reference numeral 114 denotes a keyboard, and reference numeral 115 denotes a pointing device such as a mouse.

In the present embodiment, the image forming system 100 will be described as a system in which the control apparatus 102 and the image forming apparatus 103 are provided separately, but the control apparatus 102 may be physically omitted if the processing of the control apparatus 102 can be incorporated in the image forming apparatus 103. Also, the display apparatus 113 may have a position input apparatus function such as a touch pad, and may also function as the pointing device 115.

Hardware Configuration of Image Forming Apparatus

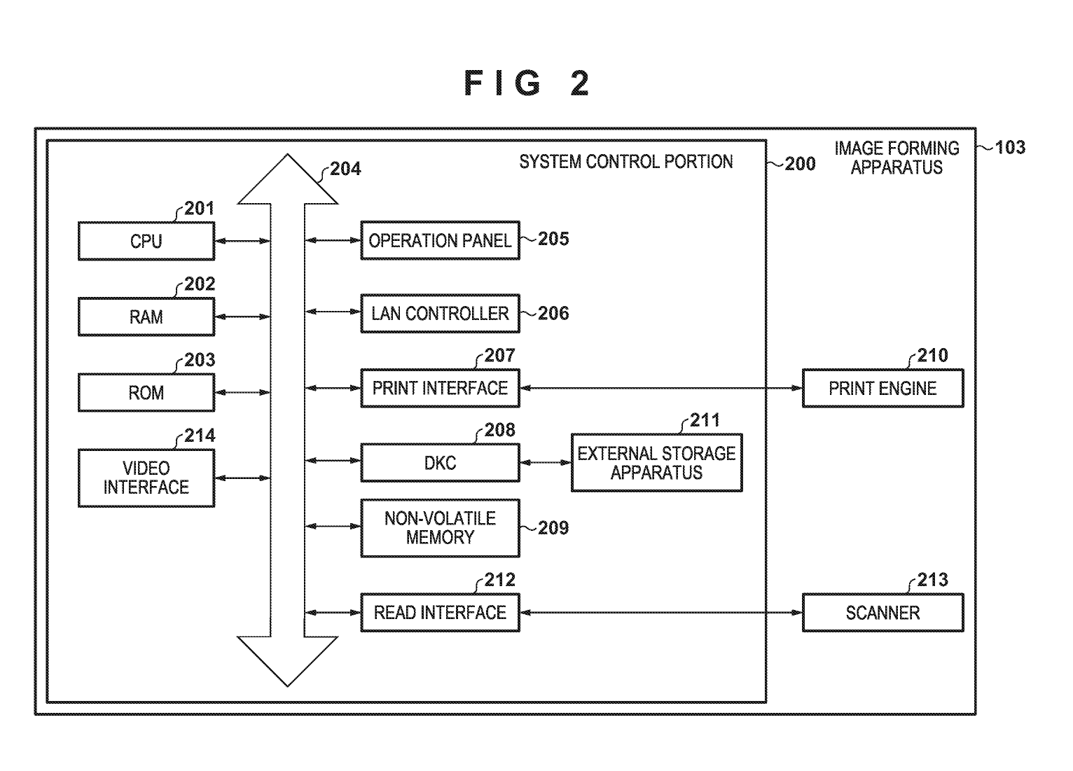

Next, an example of a hardware configuration of the image forming apparatus 103 will be described with reference to FIG. 2. As shown in FIG. 2, the image forming apparatus 103 includes, as a hardware configuration, a system control portion 200, a print engine 210, and a scanner 213. The system control portion 200 includes a CPU 201, a RAM 202, a ROM 203, an operation panel 205, a LAN controller 206, a print interface 207, a DKC 208, a non-volatile memory 209, an external storage apparatus 211, a read interface 212, and a video interface 214. These components can transmit and receive data to each other via a system bus 204.

The CPU 201 performs overall control of access to various types of devices connected to the system bus 204 based on a control program stored in the ROM 203 or the external storage apparatus 211. Also, the CPU 201 outputs an image signal as output information to the printing portion (printer engine) 210 connected via the print interface 207, and controls an image signal input from the read portion (scanner) 213 connected via the read interface 212. The CPU 201 can execute communication processing with the control apparatus 102 via the LAN controller 206.

The RAM 202 functions primarily as a main memory, a work area, and the like for the CPU 201. Access to the external storage apparatus 211 such as a hard disk drive (HDD), or an IC card is controlled by the disk controller (DKC) 208. The external storage apparatus 211 is used as a job storage region for storing an application program, font data, a form data, and the like, temporarily spooling a print job, and externally controlling the spooled job. Furthermore, the external storage apparatus 211 is also used as a temporarily held data storage region for storing image data read from the scanner 213 or image data of a print job as temporarily held data, so that the data can be looked up or printed from the network. In the present embodiment, an HDD is used as the external storage apparatus so as to store various types of logs including a job log, and an image log.

The operation panel 205 provides a user interface, software keys, and hardware keys, and is capable of accepting various types of information from a user. The non-volatile memory 209 stores various types of settings information that are set from a terminal via the operation panel 205 or a network. The video interface 214 receives image data from the control apparatus 102.

Hardware Configuration of Control Apparatus

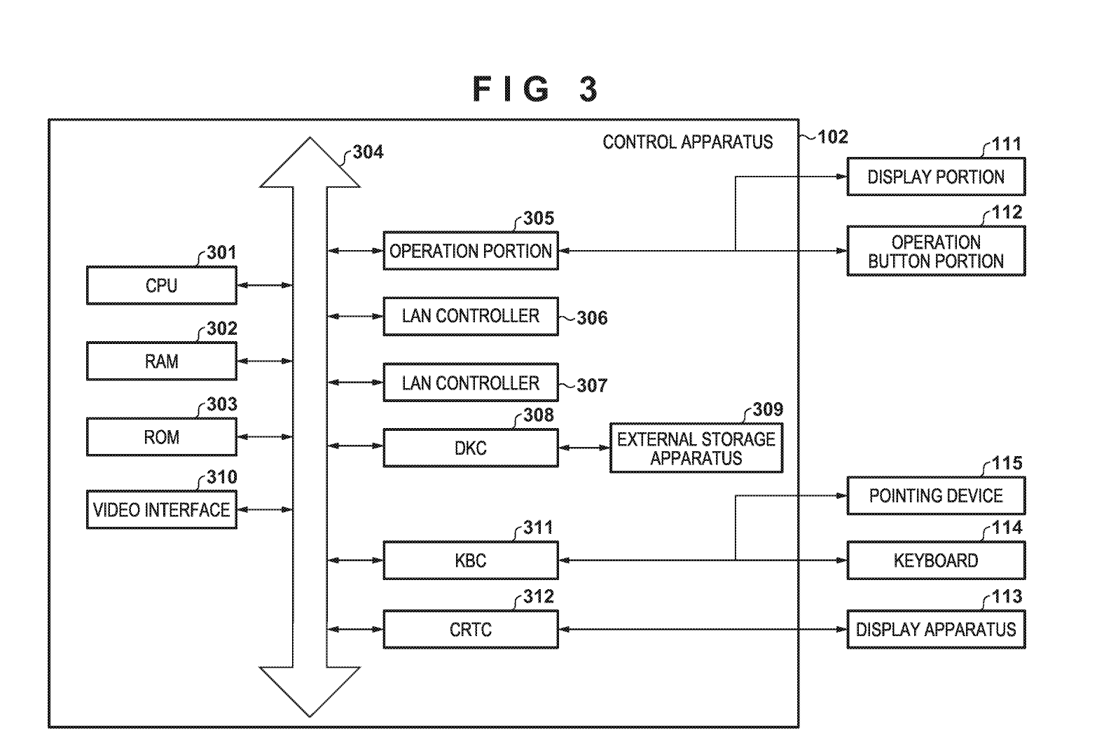

Next, an example of a hardware configuration of the control apparatus 102 will be described with reference to FIG. 3. As shown in FIG. 3, the control apparatus 102 includes a CPU 301, a RAM 302, a ROM 303, an operation portion 305, a LAN controller 306, a LAN controller 307, a DKC 308, an external storage apparatus 309, a video interface 310, a KBC 311, and a CRTC 312. These components can transmit and receive data to each other via a system bus 304.

The CPU 301 performs overall control of access to various types of devices connected to the system bus 304 based on a control program stored in the ROM 303 or the external storage apparatus 309. Also, the CPU 301 executes communication processing with the image forming apparatus 103 via the LAN controller 306. Furthermore, the CPU 301 executes communication processing with the client computer 101 and the image forming apparatus 103 that are provided on the network via the LAN controller 307. Here, the CPU 301 accepts a job for the image forming apparatus 103 transmitted from the client computer 101, and stores the job.

The RAM 302 functions primarily as a main memory, a work area, and the like for the CPU 301. Access to the external storage apparatus 309 such as a hard disk drive (HDD), or an IC card is controlled by the disk controller (DKC) 308. The external storage apparatus 309 stores an application program, font data, a form data, and the like, and temporarily spools a print job. Furthermore, the external storage apparatus 309 is used as a job storage region for re-storing a spooled job that has undergone RIP (Raster Image Processing) processing by the CPU 301.

The operation portion 305 allows the user to input various types of information via the operation button portion 112, and can display information on the display portion 111. The input information is displayed on the display portion 111. The video interface 310 transmits RIP-processed image data to the image forming apparatus 103. The keyboard controller (KBC) 311 processes the information input via the keyboard 114 and the pointing device 115 such as a mouse®. The display control portion (CRTC) 312 is internally provided with a video memory, and renders image data in the video memory in accordance with an instruction from the CPU 301, and outputs the image data rendered in the video memory to the display apparatus 113 as a video signal.

Example of Screen

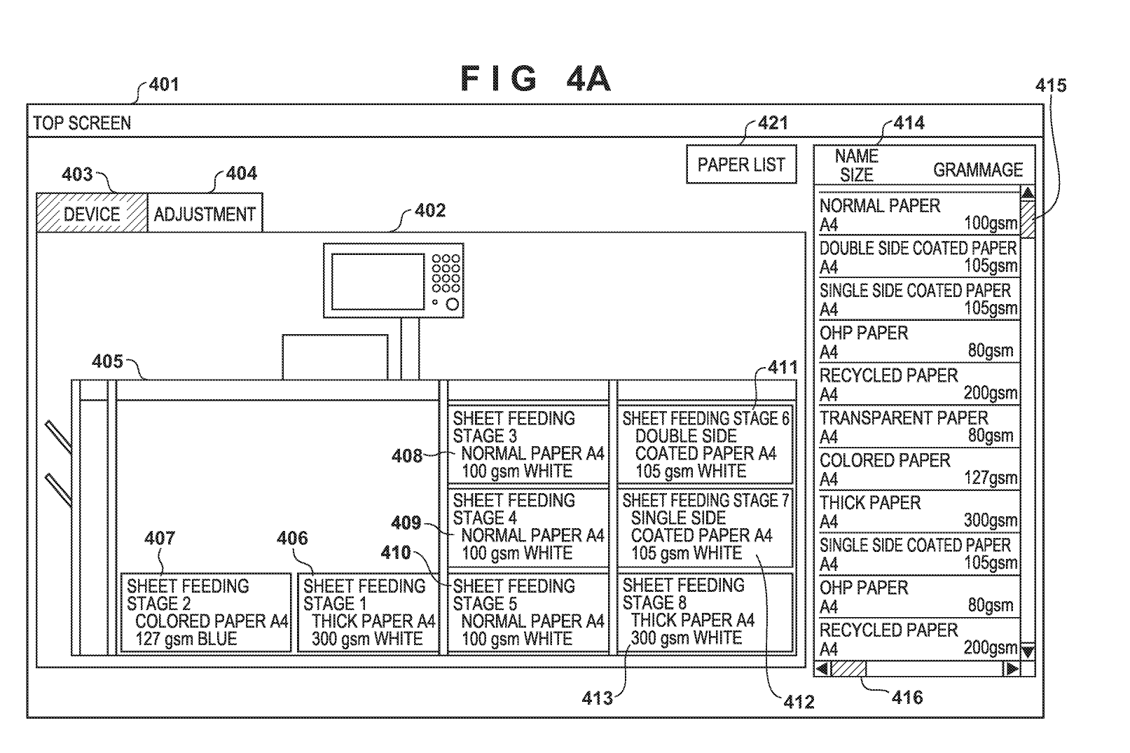

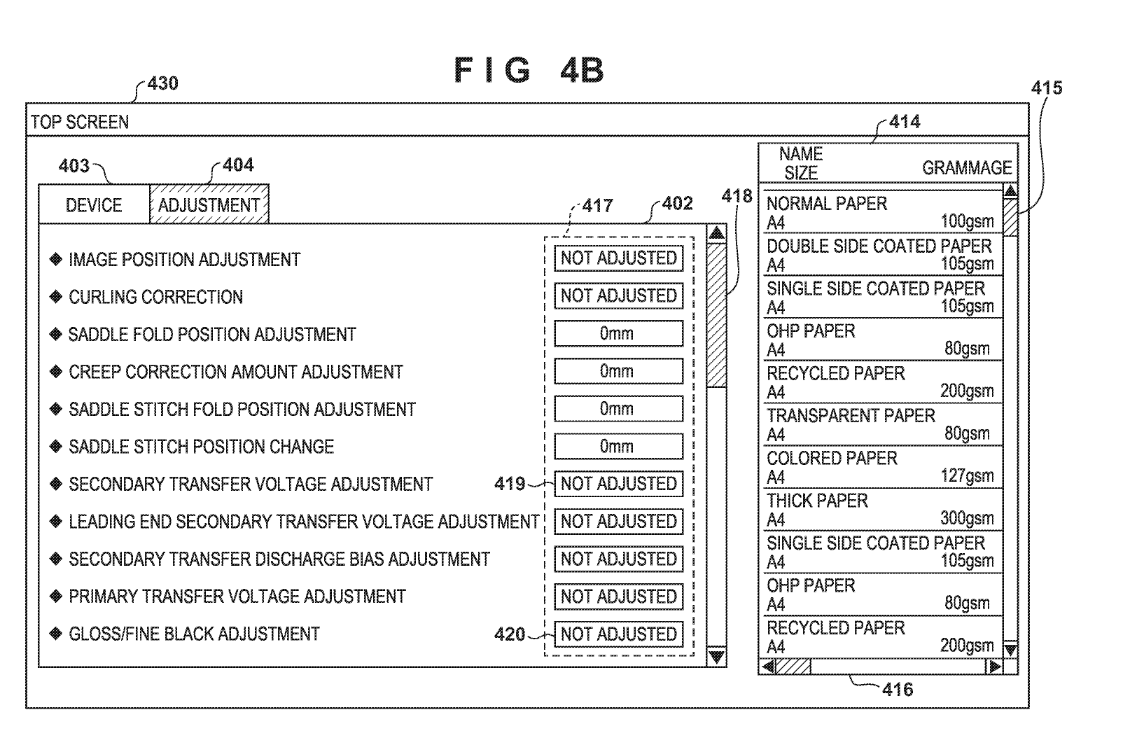

Next, an example of a configuration of a top screen of a paper management application will be described with reference to FIGS. 4A and 4B. The paper management application is an application that runs on the control apparatus 102. FIG. 4A shows a screen 401 on which sheet feeding stage information of the image forming apparatus 103 is displayed, and FIG. 4B shows a screen 430 on which buttons for making various types of adjustments and settings of the image forming apparatus 103 are displayed. The display control portion 312 renders the top screen of the paper management application in the video memory in accordance with an instruction from the CPU 301, and outputs the image data rendered in the video memory to the display apparatus 113 as a video signal so as to display the image data. The screens 401 and 430 are top screens for change screens for accepting a user operation to make a change to the settings of paper setting items.

The screen 401 of the paper management application will be described in detail. In the screen 430, the same elements as those displayed on the screen 401 are given the same reference numerals, and a description thereof will be omitted here. Reference numeral 402 denotes a display region where tab control can be carried out. By pressing a device tab 403, it is possible to display the screen 401 on which the sheet feeding stage information of the image forming apparatus 103 is displayed in the display region 402. By pressing an adjustment tab 404, it is possible to display the screen 430 on which the buttons for making various types of adjustments and settings are displayed in the display region 402. Reference numeral 405 denotes an indication that shows the connection status of the hardware options of the image forming apparatus 103 that are currently connected to the control apparatus 102. Upon activation, the paper management application acquires hardware option information of the image forming apparatus 103, and displays a correct image in accordance with the option information.

The screen 401 according to the present embodiment shows a state in which a sheet feeding apparatus including a plurality of sheet feeding stages and a paper discharge apparatus are connected. Reference numerals 406 to 413 denote sheet feeding stage buttons that respectively correspond to the sheet feeding stages. The display control portion 312 creates and arranges the sheet feeding stage buttons based on the sheet feeding stage information of the image forming apparatus 103 acquired when the paper management application was activated.

Reference numeral 414 denotes a display screen that displays paper information. For each paper, name, size information, attribute information (for example, grammage) are set. By operating a slider bar 415, it is possible to display papers other than the currently displayed papers. Also, by operating a slider bar 416, it is possible to display information of the currently displayed papers other than the paper attribute information.

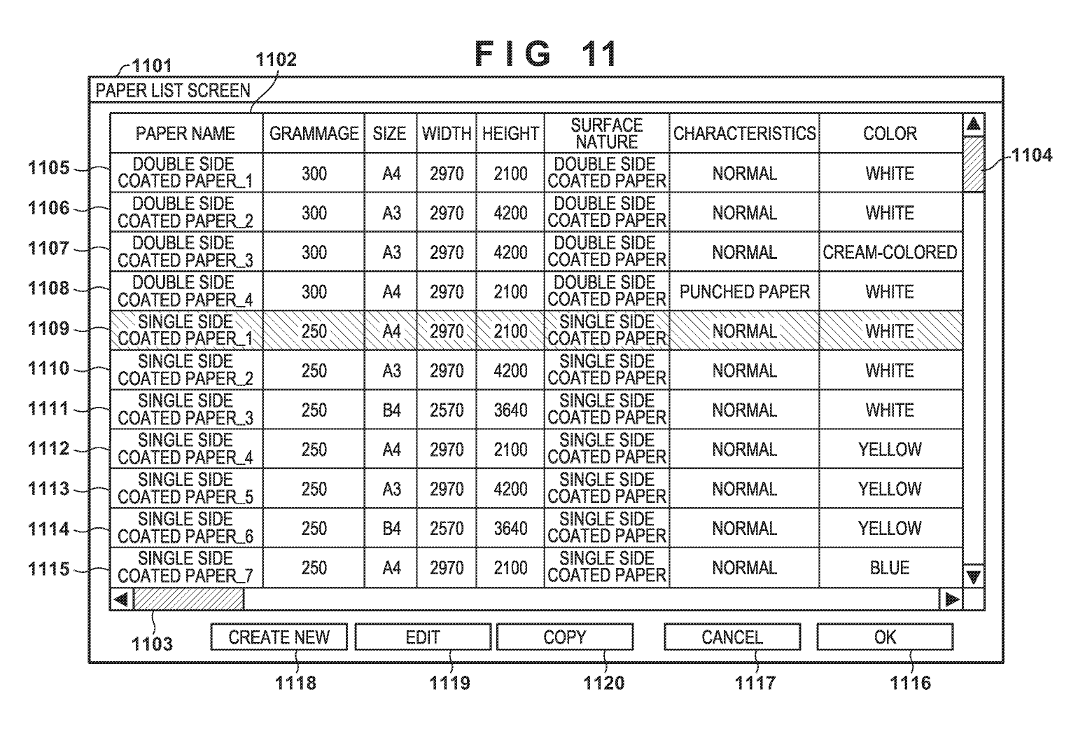

A button 421 is a button for displaying a paper list screen shown in FIG. 11. In the present embodiment, the paper management application displays a paper list screen 1101 shown in FIG. 11 in the foreground in response to the button 421 being pressed. Reference numeral 417 denotes buttons for making various types of adjustments and settings. Items that can be adjusted by the image forming apparatus 103 are displayed. Reference numeral 418 denotes a slider bar, and by operating the slider bar, it is possible to view the adjustment setting items that are not currently displayed.

Processing Procedure of Control Apparatus

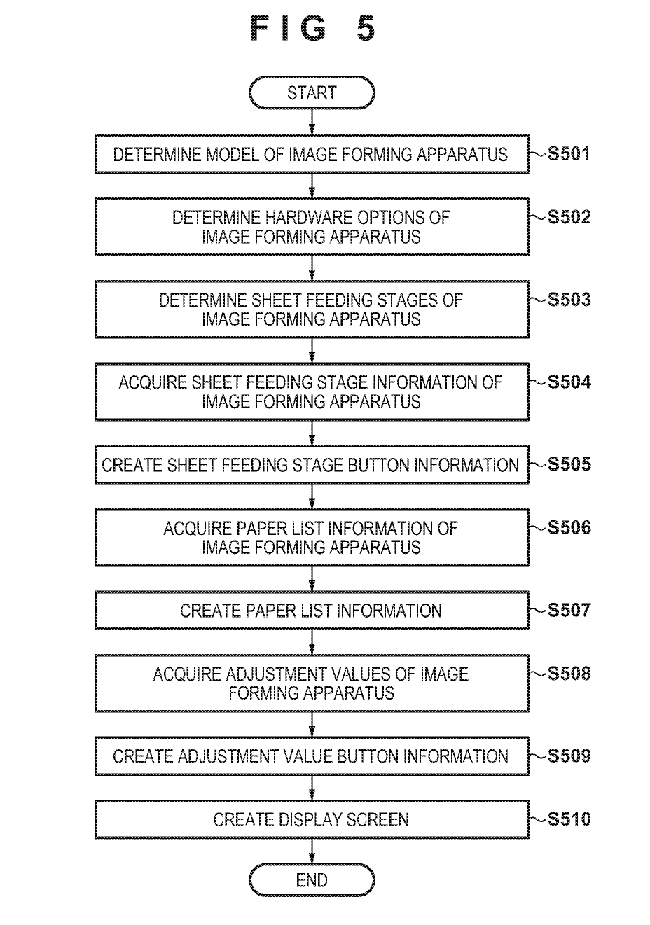

Next, a processing procedure for creating the screen 401 performed in the control apparatus 102 when the paper management application is activated will be described with reference to FIG. 5. The processing described below is implemented by, for example, the CPU 301 reading a control program stored in the HDD 309 to the RAM 302 and executing the control program.

When the paper management application is activated on the control apparatus 102, in S501, the paper management application determines the model of the image forming apparatus 103 for which paper management is to be performed. The paper management application determines the model of the image forming apparatus 103, and uses the result of determination when creating the indication 405 showing the connection status of the hardware options, or when absorbing a difference in specifications between models. To be specific, the paper management application performs communication with the image forming apparatus 103, and acquires model information from information replied in S607, which will be described later. Furthermore, the paper management application determines the model of the image forming apparatus 103 based on model determination information that is stored in advance in the image forming apparatus 103. As used herein, the term “model information” refers to product information of the image forming apparatus 103 that includes performance specifications, available services, and the like of the image forming apparatus 103. When the model has been determined in S501, the processing transitions to S502.

In S502, the paper management application performs communication with the image forming apparatus 103, and acquires hardware option information from information replied in S609, which will be described later. Then, the paper management application determines the hardware options of the image forming apparatus 103 that are connected. Furthermore, the paper management application uses the result of determination when creating the indication 405 showing the connection status of the hardware options, when specifying sheet feeding stage information, or when absorbing a difference in specifications between models. When the hardware option information has been acquired through communication with the image forming apparatus 103, the processing transitions to S503.

In S503, the paper management application performs communication with the image forming apparatus 103, and acquires sheet feeding stage information of the image forming apparatus 103 replied in S611, which will be described later. It is assumed here that the sheet feeding stage information includes a sheet feeding stage configuration such as option deck, manual feed tray, and long paper tray, as well as paper information that is set for each sheet feeding stage. Furthermore, the paper management application determines sheet feeding stages that are connected to the image forming apparatus 103 for which paper management is to be performed, and specifies the number of sheet feeding stages that are connected. When the sheet feeding stage determination has been performed in S503, the processing transitions to S504.

In S504, the paper management application performs communication with the image forming apparatus 103, and acquires paper information that is set for each sheet feeding stage from information replied in S611, which will be described later. When the paper information of each sheet feeding stage has been acquired in S504, the processing transitions to S505. In S505, the paper management application creates sheet feeding stage button information for the feeding stage buttons 406 to 413 displayed on the screen 401. When the sheet feeding stage button information has been created in S505, the processing transitions to S506.

In S506, the paper management application performs communication with the image forming apparatus 103, and acquires paper list information replied in S613, which will be described later. When the paper list has been acquired in S506, the processing transitions to S507. In S507, the paper management application creates paper list information 414 displayed on the screen 401. When the paper list information has been created in S507, the processing transitions to S508.

In S508, the paper management application performs communication with the image forming apparatus 103, and acquires adjustment values for making various types of adjustments from information replied in S615 in order to set values for the various types of adjustment buttons 417. When the adjustment values have been acquired, the processing transitions to S509. In S509, the paper management application creates, based on the acquired adjustment values, a character string to be set for each of the various types of adjustment buttons 417. If there is only one adjustment value, the adjustment value is displayed, and if there are two or more adjustment values, information indicating “adjusted” or “not adjusted” is created. When the adjustment buttons have been created in S509, the processing transitions to S510. In S510, the paper management application creates a top screen based on the model information of the apparatus acquired in S501, the option information acquired in S502, the sheet feeding stage button information created in S505, the paper list information created in S507, and the adjustment button information created in S509.

The flowchart has been explained as a flow of operations performed when the paper management application is activated. However, if necessary, the sheet feeding stage information, the paper list information, and the adjustment values of the image forming apparatus 103 may be changed while the paper management application is running. Accordingly, communication between the paper management application and the image forming apparatus 103, and update of each information associated with the change are also performed as needed irrespective of whether the operation of change was performed in the paper management application or the image forming apparatus 103. Also, it is assumed that the information is synchronized between the paper management application and the printing apparatus.

Processing Procedure of Image Forming Apparatus

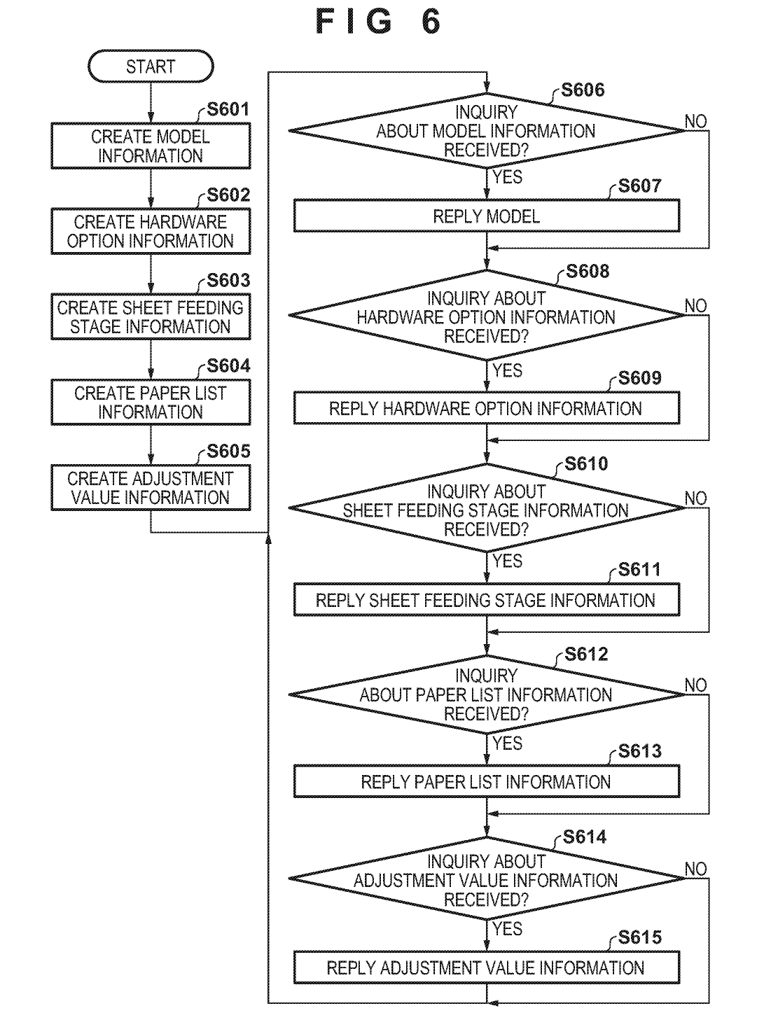

Next, a processing procedure for creating information that is synchronized through communication between the control apparatus 102 and the paper management application performed when the image forming apparatus 103 is activated will be described with reference to FIG. 6. The processing described below is implemented by, for example, the CPU 201 reading a control program stored in the HDD 211 into the RAM 202 and executing the control program.

When the image forming apparatus 103 is activated, the processing transitions to S601. In S601, the CPU 201 acquires, from the HDD 211, the model information of the image forming apparatus 103 that has been stored in advance, and creates model information data as data that can be replied. When the model information data has been created in S601, the processing transitions to S602. In S602, the CPU 201 acquires, from the HDD 211, the hardware option information regarding the hardware options connected to the image forming apparatus 103, and creates hardware option information data as data that can be replied. When the hardware option information data has been created in S602, the processing transitions to S603. In S603, the CPU 201 acquires the sheet feeding stage information of the image forming apparatus 103 from the acquired hardware option information and the HDD 211, and creates sheet feeding stage information data as data that can be replied. When the sheet feeding stage information data has been created in S603, the processing transitions to S604. In S604, the CPU 201 acquires, from the HDD 211, the paper list information of the image forming apparatus 103, and creates paper list information data as data that can be replied. When the paper list information data has been created in S604, the processing transitions to S605. In S605, the CPU 201 acquires, from the HDD 211, the adjustment value information of each paper, and creates adjustment value information data as data that can be replied. It is desirable that the adjustment value information is acquired for all items that can be adjusted by the image forming apparatus 103. When the adjustment value information data has been created in S605, the processing transitions to S606.

In S606, the CPU 201 determines whether or not an inquiry about model information has been received from the control apparatus 102. If it is determined that an inquiry about the model information acquired in S501 of the paper management application activation flowchart has been received, the processing transitions to S607, where the CPU 201 replies the model information created in S601, and the processing transitions to S608. If it is determined in S606 that an inquiry about the model information has not been received, the processing transitions to S608.

In S608, the CPU 201 determines whether or not an inquiry about hardware option information has been received from the control apparatus 102. If it is determined that an inquiry about the hardware option information acquired in S502 of the paper management application activation flowchart has been received, the processing transitions to S609. In S609, the CPU 201 replies the hardware option information created in S602, and the processing transitions to S610. If, on the other hand, it is determined in S608 that an inquiry about the hardware option information has not been received, the processing transitions to S610.

In S610, the CPU 201 determines whether or not an inquiry about sheet feeding stage information has been received from the control apparatus 102. If it is determined that an inquiry about the sheet feeding stage information acquired in S503 and S504 of the paper management application activation flowchart has been received, the processing transitions to S611. In S611, the CPU 201 replies the sheet feeding stage information created in S603 to the control apparatus 102, and the processing transitions to S612. The processing also transitions to S612 if it is determined in S610 that an inquiry about the sheet feeding stage information has not been received.

In S612, the CPU 201 determines whether or not an inquiry about paper list information has been received from the control apparatus 102. If it is determined that an inquiry about the paper list information acquired in S506 and S507 of the paper management application activation flowchart has been received, the processing transitions to S613. In S613, the CPU 201 replies the paper list information created in S604 to the paper management application, and the processing transitions to S614. If it is determined in S612 that an inquiry about the paper list information has not been received, the processing transitions to S614.

In S614, the CPU 201 determines whether or not an inquiry about adjustment value information has been received from the control apparatus 102. If it is determined that an inquiry about the adjustment value information acquired in S508 of the paper management application activation flowchart has been received, the processing transitions to S615. In S615, the CPU 201 replies the adjustment value information created in S605 to the control apparatus 102, and the processing returns to S606. If it is determined in S614 that an inquiry about the adjustment value information has not been received, the processing returns to S606.

The sheet feeding apparatus according to the present embodiment is an example of a sheet feeding portion, and may be a sheet feeding portion of any other mechanism such as an inserter (a paper inserting apparatus located on a paper conveyance path after printing) or a manual feed tray, and thus there is no limitation on the form thereof. As used herein, the term “manual feed tray” refers to a tray that is attached to the image forming apparatus and in which a paper that has a size outside the sizes that can be loaded in the sheet feeding apparatus is loaded.

Paper Setting Screen

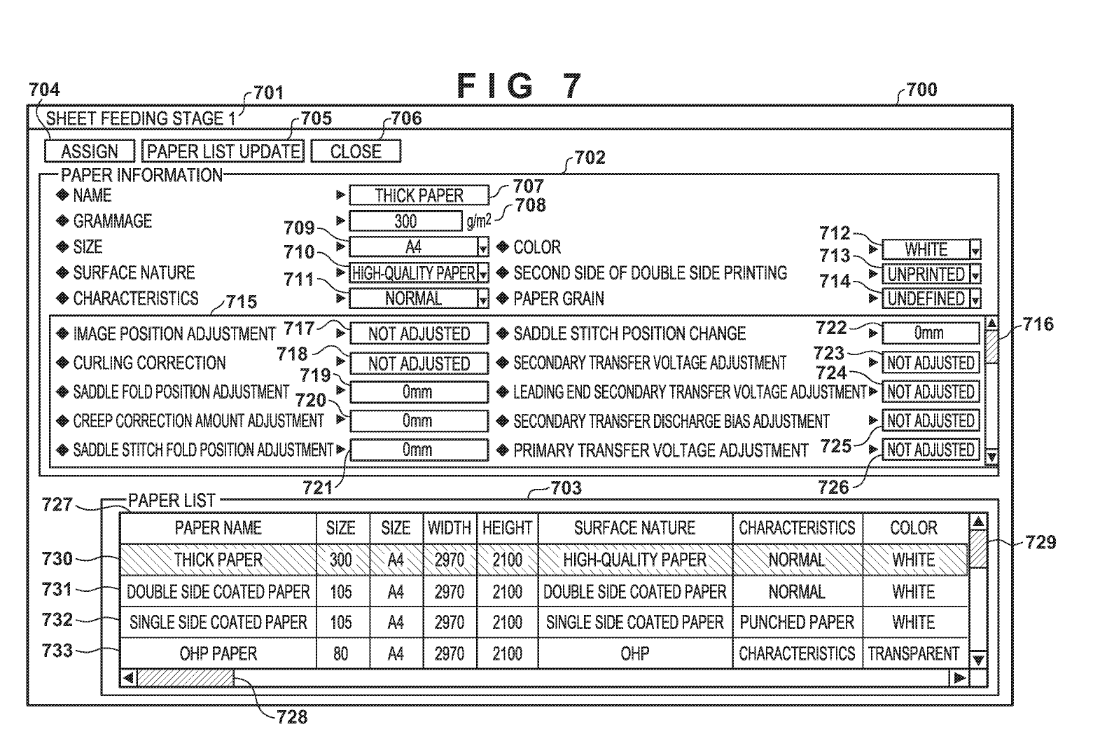

Referring back to FIG. 4A, when the button 406 for sheet feeding stage 1 that is displayed on the screen 401 is pressed by using the pointing device 115 or the like, a paper setting screen 700 for sheet feeding stage 1 shown in FIG. 7, which is an example of a change screen, is displayed. The buttons 407 to 413 are also configured to make transition to their corresponding paper setting screens as with the button 406, and thus a detailed description thereof is omitted here. In the present embodiment, although the details will not be described, the term “sheet feeding stage” of course encompasses any sheet feeding apparatus including an inserter, a manual feed tray, and the like. In addition, in the following description, a description of the use of the pointing device 115 or the like at the time of operating the application such as pressing a button will be omitted, but of course the operation is performed by using such an input device.

FIG. 7 shows a paper setting screen 700 for sheet feeding stage 1. In accordance with an instruction from the CPU 301, the paper setting screen 700 for sheet feeding stage 1 is rendered in the video memory, and the image data rendered in the video memory is output to the display apparatus 113 as a video signal, and displayed on the display apparatus 113. Reference numeral 701 is a top screen for sheet feeding stage 1 screen. On the top screen 701, a paper information display region 702, a paper list display region 703, an assign button 704, a paper list update button 705, and a close button 706 are displayed. The paper information display region 702 displays the settings information of the currently selected paper. In the case where the screen 701 appears in response to any of the sheet feeding stage buttons 407 to 413 being pressed, the paper information of the paper currently assigned to the corresponding sheet feeding stage is displayed. The paper list display region 703 displays the paper information managed by the control apparatus 102 and the image forming apparatus 103 in the form of a list. When a paper is selected from the paper list displayed in the paper list display region 703, the paper information of the selected paper is displayed in the paper information display region 702.

First, input items in the paper information display region 702 will be described. Reference numeral 707 denotes a text field in which paper name can be input. In the case of changing the name, characters can be input to the text area by using the keyboard 114 or the like. In the following description, a description of the use of the keyboard 114 or the like at the time of input will be omitted, but of course characters are input by using such an input device. In order to reflect the changed information on the paper information, the paper list update button 705 is pressed. By pressing the paper list update button 705, the paper information of the control apparatus 102 and the image forming apparatus 103 can be changed. Reference numeral 708 denotes a text field in which grammage can be input. The operation is the same as that performed on the name text area 707, and thus a description thereof is omitted here. Reference numeral 709 denotes a combo box for displaying paper size information. A desired size can be set by selecting from the size information displayed in the form of a list. In order to reflect the changed information on the paper information, the paper list update button 705 is pressed. By pressing the paper list update button 705, the paper information of the control apparatus 102 and the image forming apparatus 103 can be changed.

Reference numeral 710 denotes a combo box for displaying surface nature information. The operation is the same as that performed on the size combo box 709, and thus a description thereof is omitted here. Reference numeral 711 denotes a combo box for displaying characteristics information. The operation is the same as that performed on the size combo box 709, and thus a description thereof is omitted here. Reference numeral 712 denotes a combo box for displaying color information. The operation is the same as that performed on the size combo box 709, and thus a description thereof is omitted here. Reference numeral 713 denotes a combo box for displaying information regarding the second side of double side printing. The operation is the same as that performed on the size combo box 709, and thus a description thereof is omitted here. Reference numeral 714 denotes a combo box for displaying paper grain information. The operation is the same as that performed on the size combo box 709, and thus a description thereof is omitted here.

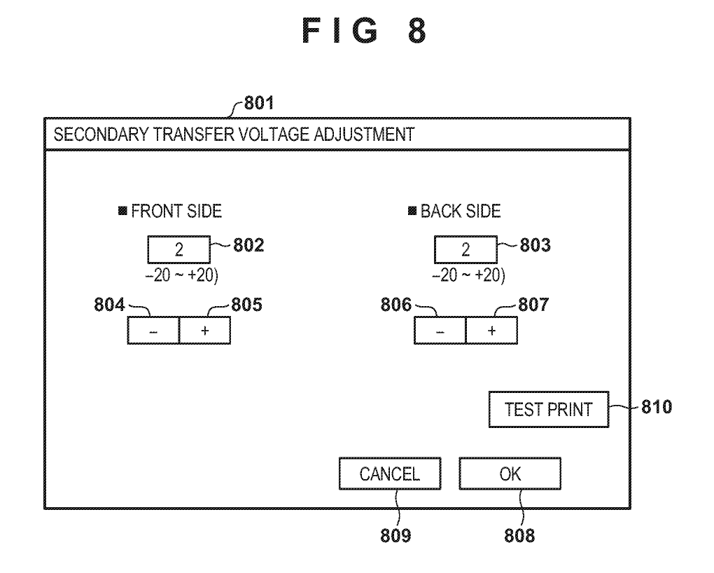

Reference numeral 715 denotes a region in which adjustment-related settings are collectively displayed. Because there are so many adjustment-related setting items, it is not possible to display all of the setting items within this screen. To view adjustment setting items that are not currently displayed, by operating a slider bar 716, set values can be displayed. Reference numeral 717 denotes a setting item button for image position adjustment, and this button shows whether adjustment has already been performed for the currently selected paper. If adjustment has already been performed for the currently selected paper, “adjusted” is displayed, and if adjustment has not been performed for the currently selected paper, “not adjusted” is displayed. By pressing the setting item button 717 for image position adjustment, transition is made to an adjustment screen 801 as shown in FIG. 8, which will be described later. On this adjustment screen 801, any type of adjustment value can be input. In order to reflect the changed information on the paper information, the paper list update button 705 is pressed. By pressing the paper list update button 705, the paper information of the control apparatus 102 and the image forming apparatus 103 can be changed.

Reference numeral 718 denotes a setting item button for curling correction. The operation is the same as that performed on the setting item button 717 for image position adjustment, and thus a description thereof is omitted here. Reference numeral 719 denotes a setting item button for saddle fold position adjustment. This button shows the current adjustment value in millimeters. By pressing the setting item button 719 for saddle fold position adjustment, transition is made to an adjustment screen 801 as shown in FIG. 8, which will be described later. On this adjustment screen 801, any type of adjustment value can be input. In order to reflect the changed information on the paper information, the paper list update button 705 is pressed. By pressing the paper list update button 705, the paper information of the control apparatus 102 and the image forming apparatus 103 can be changed. Reference numeral 720 denotes a setting item button for creep correction amount adjustment. The operation is the same as that performed on the setting item button 719 for saddle fold position adjustment, and thus a description thereof is omitted here. Reference numeral 721 denotes a setting item button for saddle stitch fold position adjustment. The operation is the same as that performed on the setting item button 719 for saddle fold position adjustment, and thus a description thereof is omitted here.

Reference numeral 722 denotes a setting item button for saddle stitch position change. The operation is the same as that performed on the setting item button 719 for saddle fold position adjustment, and thus a description thereof is omitted here. Reference numeral 723 denotes a setting item button for secondary transfer voltage adjustment. The operation is the same as that performed on the setting item button 717 for image position adjustment, and thus a description thereof is omitted here. Reference numeral 724 denotes a setting item button for leading end secondary transfer voltage adjustment. The operation is the same as that performed on the setting item button 717 for image position adjustment, and thus a description thereof is omitted here. Reference numeral 725 denotes a setting item button for secondary transfer discharge bias adjustment. The operation is the same as that performed on the setting item button 717 for image position adjustment, and thus a description thereof is omitted here. Reference numeral 726 denotes a setting item button for primary transfer voltage adjustment. The operation is the same as that performed on the setting item button 717 for image position adjustment, and thus a description thereof is omitted here.

In the present embodiment, a configuration will be described in which a message is displayed that indicates that no changes can be made to the paper settings because a sheet feeding stage in which the selected paper is loaded is in a paper change prohibition state, but it is also possible to use a configuration in which a message indicating that the required items for changing the paper settings have not been sufficiently input, the result of a conformity check of input values, or the like is displayed.

Next, the paper list display region 703 will be described. Reference numeral 727 denotes a table for displaying a paper list. Paper attribute information is shown in the columns, and papers are shown in the rows. By operating a slider bar 728, it is possible to display information of the currently displayed papers other than the paper attribute information. Likewise, by operating a slider bar 729, it is possible to display papers other than the currently displayed papers.

Reference numeral 730 denotes a paper displayed in the paper display region 702, and is highlighted so as to show that the paper has been selected. Reference numerals 731 to 733 each denote a paper that is not displayed in the paper display region 702. If any one of the papers 731 to 733 that are not selected is selected on the paper list table 727, the information of the newly selected paper is displayed in the paper display region 702. If the assign button 704 is pressed in this state, the newly selected paper can be assigned to sheet feeding stage 1. To end the flowchart without making any change to the settings, the close button 706 is pressed.

Referring back to FIG. 4B, an example of setting adjustment values will be described by taking a secondary transfer voltage adjustment button 419 as an example. The same processing as that performed when the secondary transfer voltage adjustment button 419 is pressed is also performed when the button 723 shown in FIG. 7 is pressed. When a paper is selected from the paper list 414, and the secondary transfer voltage adjustment button 419 is pressed, transition is made to a secondary transfer voltage adjustment screen 801 shown in FIG. 8. In accordance with an instruction from the CPU 301, the secondary transfer voltage adjustment screen 801 shown in FIG. 8 is rendered in the video memory, and the image data rendered in the video memory is output to the display apparatus 113 as a video signal, and displayed on the display apparatus 113. The adjustment screen 801 is a screen on which secondary transfer voltage adjustment values can be changed. Reference numeral 802 denotes a text box for adjusting the voltage value when toner is transferred onto the front side of paper, and reference numeral 803 denotes a text box for adjusting the voltage value when toner is transferred onto the back side of paper. It is possible to directly input a numerical value by selecting a value in each of the text boxes, but it is also possible to change the numerical value by pressing a minus (−) button 804 or 806, or a plus (+) button 805 or 807.

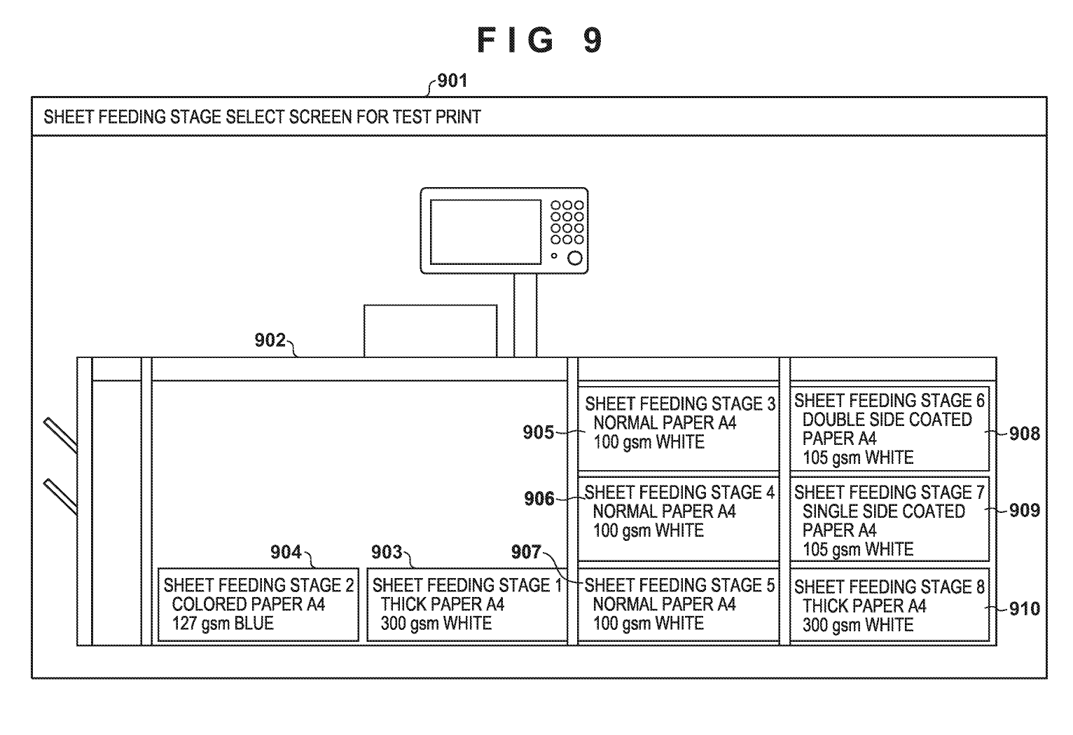

In order to reflect the set numerical values, an OK button 808 is pressed. In response to the OK button 808 being pressed, the paper management application stores the set values, and at the same time, transmits the set values so as to change the set values of the image forming apparatus 103. Upon receiving the set values, the image forming apparatus 103 changes the set values for secondary transfer voltage to the received values. When the OK button 808 is pressed, the display of the adjustment screen 801 ends. When a cancel button 809 is pressed, the display of the adjustment screen 801 ends without reflecting the values set in the text boxes 802 and 803 on the adjustment values for secondary transfer voltage. A test print button 810 is a button for executing a test print to check how the adjusted set values have changed the printed result. When the test print button 810 is pressed, transition is made to a sheet feeding stage select screen 901 for test print shown in FIG. 9.

In accordance with an instruction from the CPU 301, the sheet feeding stage select screen 901 for test print is rendered in the video memory, and the image data rendered in the video memory is output to the display apparatus 113 as a video signal, and displayed on the display apparatus 113. The sheet feeding stage select screen 901 for test print is a screen in which an image screen of the image forming apparatus 103 and sheet feeding stage buttons are provided. Reference numeral 902 is a diagram showing the connection status of the hardware options of the image forming apparatus 103 that is currently connected to the control apparatus 102. Reference numerals 903 to 910 denote sheet feeding stage buttons. A sheet feeding stage for which a secondary transfer voltage adjustment test is to be carried out is selected, and printing can be performed using the selected sheet feeding stage. It is unnecessary to select a sheet feeding stage on the sheet feeding stage select screen 901 in the case where the button 723 was pressed because the sheet feeding stage has already been determined. In this case, the operation of displaying the screen shown in FIG. 9 may be omitted, or it is also possible to display the screen shown in FIG. 9 such that the selected sheet feeding stage can be easily recognized.

If a button 903 for sheet feeding stage 1 is pressed, the paper management application transmits, to the image forming apparatus 103, the secondary transfer voltage adjustment values 802 and 803 shown in FIG. 8 and test print implementation information. The image forming apparatus 103 implements a test print based on the received data.

### First Embodiment

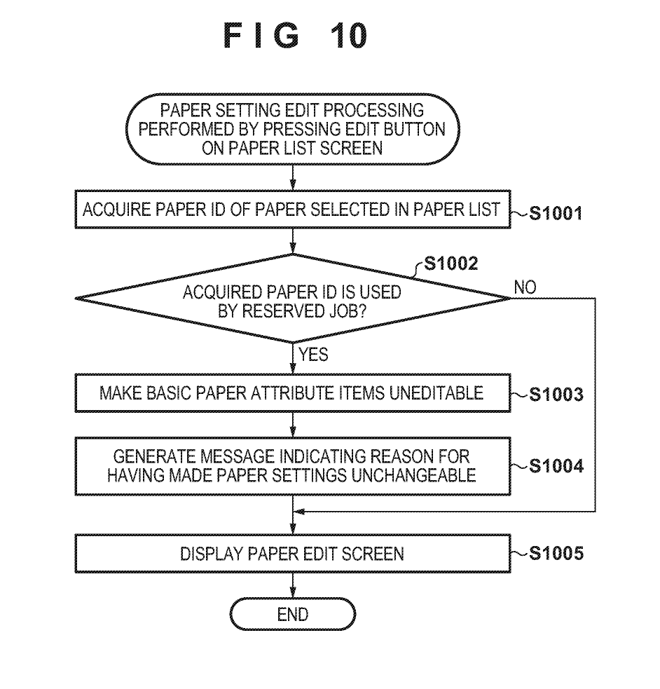

Hereinafter, a first embodiment according to the present invention will be described. Processing according to the present embodiment performed by the control apparatus 102 and the image forming apparatus 103 will be described with reference to the flowchart shown in FIG. 10. A program of the control apparatus 102 according to this flowchart is stored in the HDD 309 shown in FIG. 3, and the program is read into the RAM 302, and executed by the CPU 301.

The paper management application displays a paper list screen 1101 shown in FIG. 11 in the foreground of the display apparatus 113 when the button 421 shown in FIG. 4A is pressed. The paper list screen 1101 for activating a paper edit screen (an example of a change screen) will now be described. In accordance with an instruction from the CPU 301, the paper list screen 1101 is rendered in the video memory, and the image data rendered in the video memory is output to the display apparatus 113 as a video signal, and displayed on the display apparatus 113. The paper list screen 1101 shown in FIG. 11 is a top screen for paper list screen. Reference numeral 1102 denotes a table for displaying a paper list. Paper attribute information is shown in the columns, and papers are shown in the rows. By operating a slider bar 1103, it is possible to display information of the currently displayed papers other than the paper attribute information. Likewise, by operating a slider bar 1104, it is possible to display papers other than the currently displayed papers.

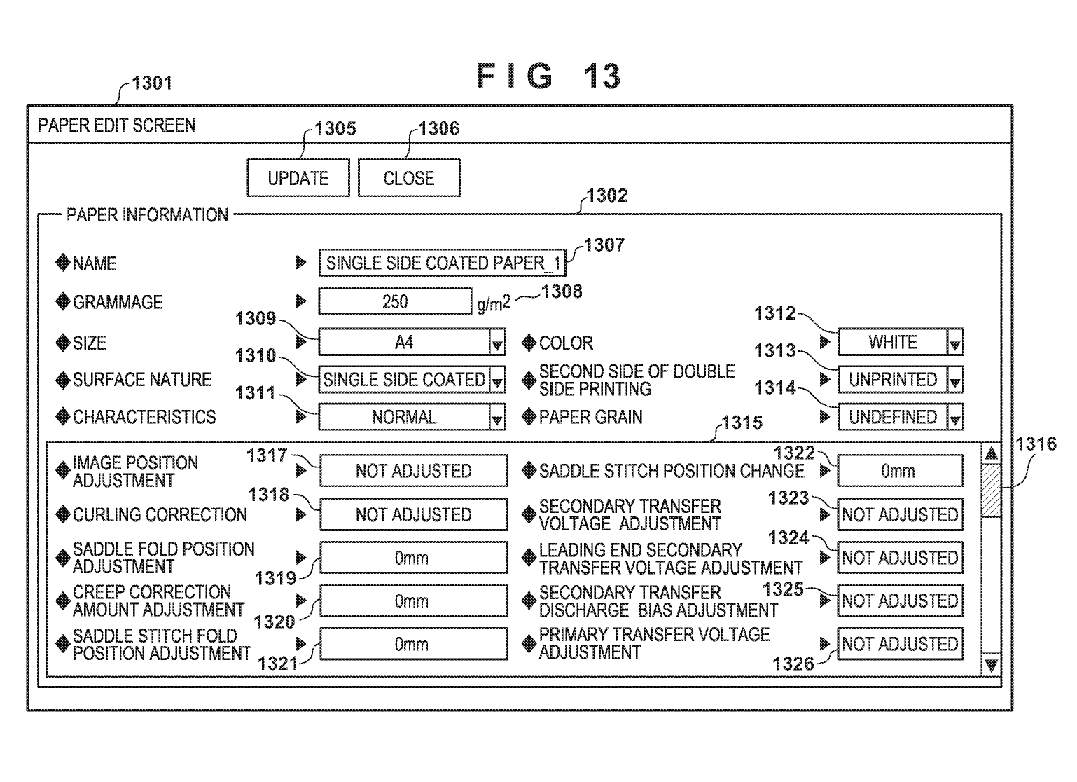

Reference numerals 1105 to 1115 denote papers that are currently displayed in the paper list 1102, with reference numeral 1109 being in a selected state and thus being highlighted in a white-black inverted manner from those that are in a non-selected state so that it can be visually understood that 1109 has been selected. Reference numerals 1105 to 1108 and 1110 to 1115 are in a non-selected state. If an OK button 1116 is pressed, settings changes are reflected on the settings of the paper in a selected state. When a cancel button 1117 is pressed, the settings are canceled. When a create new button 1118 is pressed, a paper create screen for registering a new paper is displayed. When an edit button 1119 is pressed, a paper edit screen (1301 shown in FIG. 13) for viewing and changing the settings of the selected paper (the paper 1109 in this example) is displayed. When a copy button 1120 is pressed, a paper edit screen for copying the selected paper (the paper 1109 in this example) and changing the settings of the selected paper is displayed.

When the edit button 1119 is pressed while the paper 1109 is selected on the paper list screen 1101 shown in FIG. 11, the paper management application starts paper setting edit processing shown in FIG. 10. First, in S1001, the paper management application acquires the paper ID of the paper 1109 in order to look up the paper settings of the paper 1109 selected in the paper list 1102. As used herein, the term “paper ID” refers to an identifier for individually identifying a paper. For example, in this example, the paper ID corresponds to paper name. Accordingly, the paper ID of the paper selected in the example shown in FIG. 11 is “single side coated paper_1”.

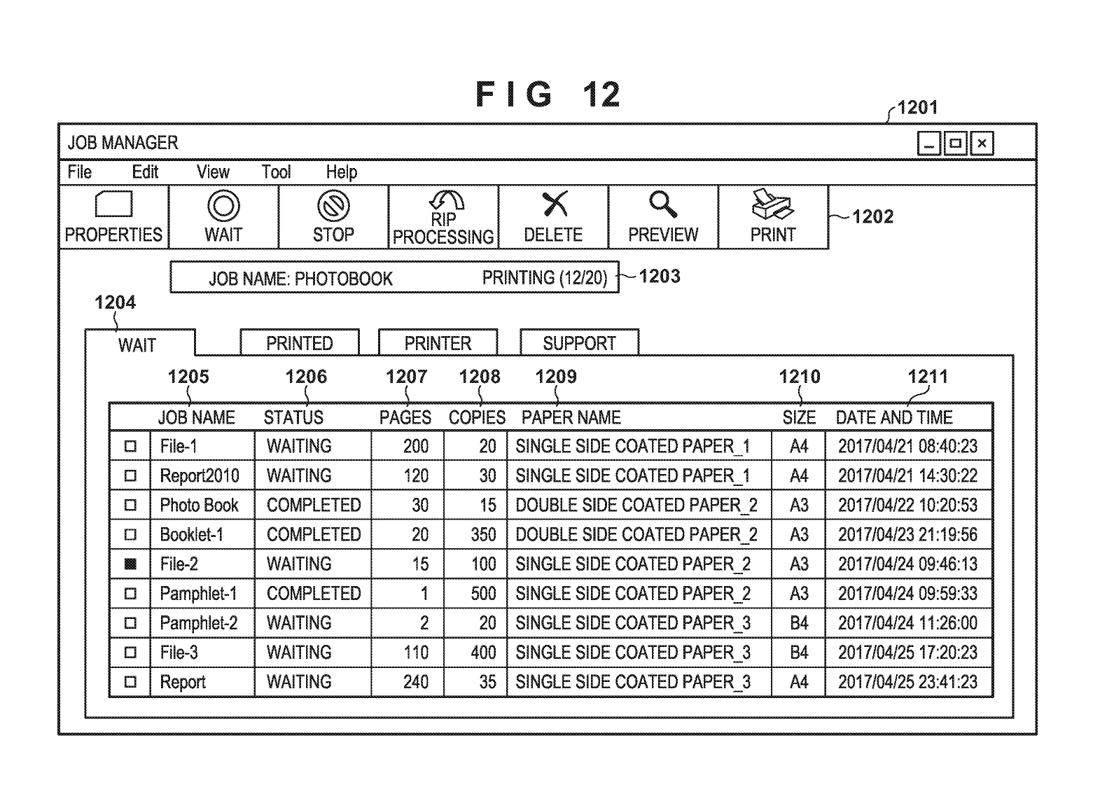

Here, a job manager will be described with reference to FIG. 12. The job manager runs on the control apparatus 102. The job manager is one of the utilities dedicated for the control apparatus 102, and manages print jobs stored in the control apparatus 102. A screen 1201 is a window screen for the job manager. With a command tool bar 1202, the job manager provides the following instructions for the selected print job. Specific examples of the instructions include an instruction to display properties (attributes), an instruction to move to a wait queue, an instruction to stop the print job, an instruction to perform RIP (developing into image data) processing, an instruction to cancel the print job, an instruction to show a preview of the print job, an instruction to print the print job, and the like. The job manager displays the current status in a status display portion 1203. In the example shown in FIG. 12, the status display portion 1203 indicates that a print job with a job name “photobook” is in progress, with the twelfth of a total of twenty copies being in a printing state (the job being in progress). In a wait queue 1204, a list of reserved jobs that are stored in the control apparatus 102 is displayed. The displayed list includes the following items. Job name 1205 indicates the name of a print job. Status 1206 indicates the state of PDL data in the wait queue. “Waiting” shown in status 1206 indicates that the print job has been stored in PDL data. “Completed” shown in status 1206 indicates that the print job has been developed and stored as image data. Pages 1207 indicates the number of pages of the print job. Copies 1208 indicates the number of copies of the print job. Paper name 1209 indicates the name of paper used in the print job. Size 1210 indicates the size of the paper used in the print job. Date and time 1211 indicates the date and time when the print job was input into the wait queue.

Referring back to FIG. 10, in S1002, the paper management application searches the wait queue of the job manager for a reserved job that uses a paper that has the same paper ID as the paper ID acquired in S1001. In the example shown in FIG. 11, the paper ID of the selected paper is “single side coated paper_1”. On the other hand, as shown in FIG. 12, “single side coated paper_1” is used by the reserved job “File-1”. In this case, as a result of the search processing, the paper management application acquires, as the search result, information indicating that the paper ID indicating “single side coated paper_1” is used by the reserved job “File-1”. If it is determined that the paper ID is used by a reserved job, the paper management application advances the processing to S1003. If it is determined that the paper ID is used by none of the reserved jobs, the processing transitions to S1005, where a paper edit screen as shown in FIG. 13, which will be described later, is displayed without performing any processing, and the flowchart ends.

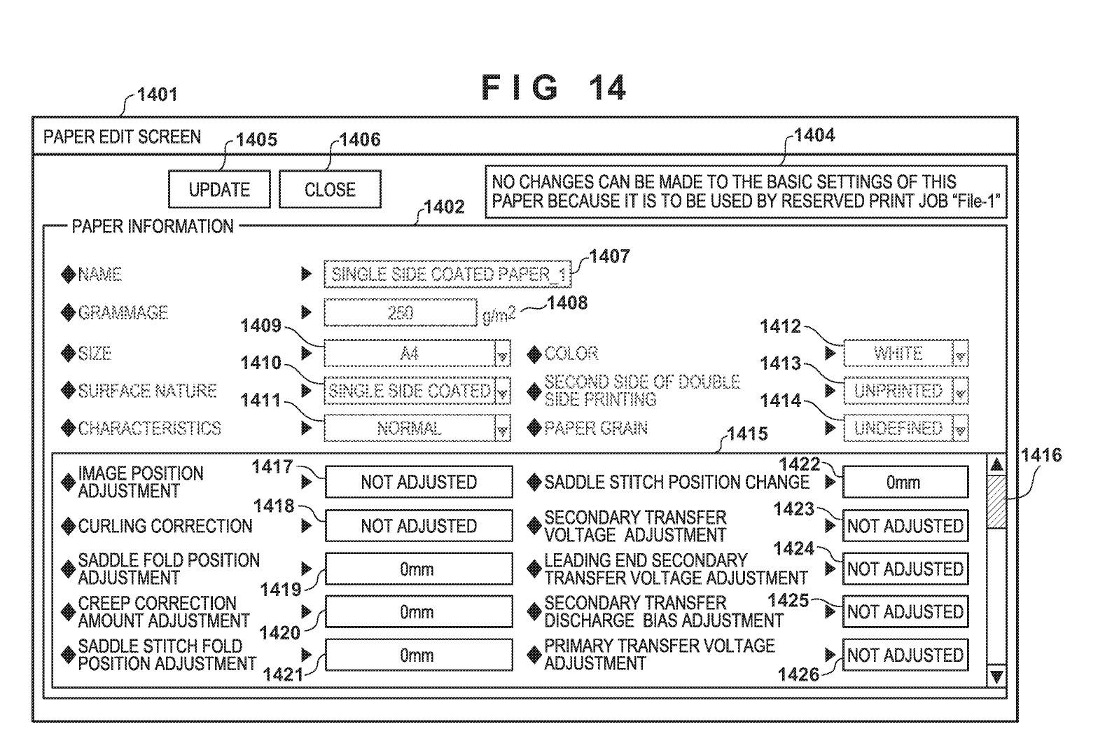

Here, details of the processing performed in steps S1002 to S1005 will be described with reference to FIGS. 13 and 14. FIG. 13 shows a paper edit screen for editing the paper designated in FIG. 11. A difference from FIG. 7 is that the paper list display region 703 and a button that corresponds to the button 704 are not provided. If it is determined in S1002 that the acquired paper ID is used by none of the reserved jobs, the paper management application displays the paper edit screen shown in FIG. 13 without performing any processing, and ends the flowchart. If, on the other hand, it is determined in S1002 that the acquired paper ID is used by the reserved job, in S1003, control is performed on the screen so as to prohibit (restrict) editing basic paper settings, as indicated by reference numerals 1407 to 1414 in FIG. 14. In the present embodiment, the screen is brought into an unchangeable state by graying out basic paper setting items. Performing control to provide a grayed-out screen so as to prohibit changes to the settings is merely an example, and it is also possible to use any other methods to prohibit changes to the settings. For example, it is possible to hide the setting items on which setting changes are prohibited. As used herein, the term “basic paper setting item” refers to a setting item relating to all jobs that use a paper of the same paper type. Next, in S1004, the paper management application generates a display message in order to display the reason for having brought the screen into a paper change prohibition state in S1003 in a message field 1404 shown in FIG. 14. In the present embodiment, the reason for having made the basic paper setting items unchangeable is displayed together with the job name of the reserved job in which the paper ID is used. Furthermore, in S1005, the paper management application displays a paper edit screen including the generated display message, and the processing ends.

In this way, a setting item other than the basic setting items of the paper to be used by the reserved job such as paper size and paper type is allowed to be edited, and it is therefore possible to make adjustment to the settings of the paper to be used by the reserved job. In addition, because the basic paper setting items are prohibited from being edited, it is also possible to prevent the problem that printing cannot be performed at the time of executing the reserved job. In the present embodiment, as the basic setting items that can be changed, paper name, grammage, size, surface nature, characteristics, color, second side of double side printing, and paper grain are used, but the setting items are not limited thereto. For example, in the present embodiment, “color” is also set as an edit prohibition item, but may be set as an editable item if it does not affect printing. It is also possible to prohibit editing, other than the setting items mentioned above, setting items that may cause a problem on a printed matter.

After that, for example, the operator presses a button 1423 on a paper edit screen 1401 shown in FIG. 14, and inputs the amount of correction on the displayed secondary transfer voltage adjustment screen 801. After having input the amount of correction, the operator presses the button 808 so as to store the setting change. After that, when the operator selects the job name “File-2” from the wait queue on the screen 1201 of the job manager, and presses a print button, printing is performed using the paper for which the secondary transfer voltage has been adjusted to be optimal.

As described above, the control apparatus according to the present embodiment accepts one or more job reservations for the image forming apparatus, and makes settings on a plurality of setting items for each paper type of paper used by the image forming apparatus so as to form an image thereon. Also, upon selecting a paper type for which settings are to be made, the control apparatus according to the present embodiment determines whether or not there is a job that uses a paper of the selected paper type in the accepted jobs. Furthermore, if it is determined that there is a job that uses a paper of the selected paper type in the accepted jobs, the control apparatus according to the present embodiment performs control on the selected paper type so as to impose a setting restriction to a portion of the plurality of setting items, and allow settings to be made on another setting items. By doing so, even after a job has been reserved in the wait queue, the operator can appropriately make various types of adjustments on the paper to be used by the reserved job within the range possible (on the unrestricted setting items). The control apparatus described above may be incorporated in an image forming apparatus.

### Second Embodiment

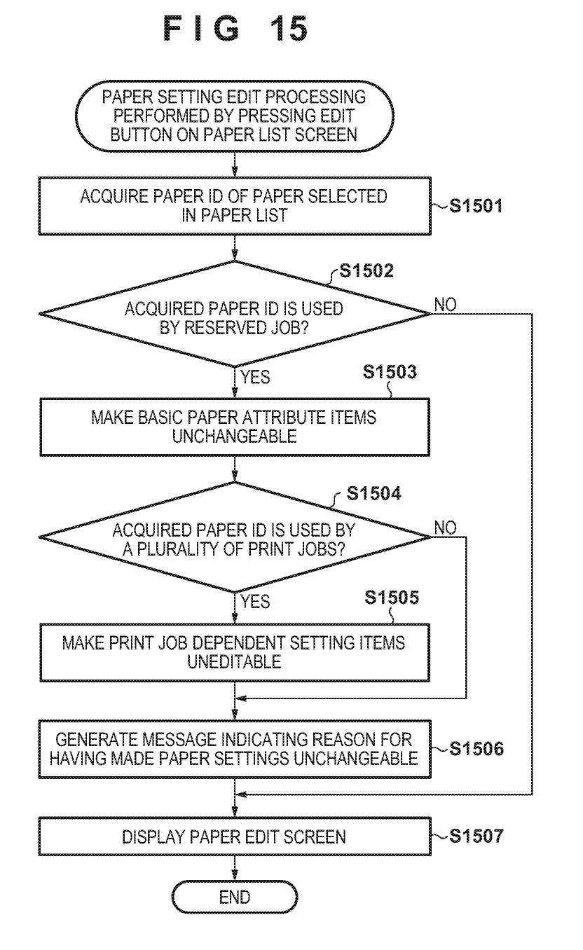

Hereinafter, a second embodiment according to the present invention will be described. In the present embodiment, an example will be described in which there are a plurality of reserved jobs that use a paper that has the same paper ID as the paper ID selected in the paper list screen 1101, with reference to the flowchart shown in FIG. 15.

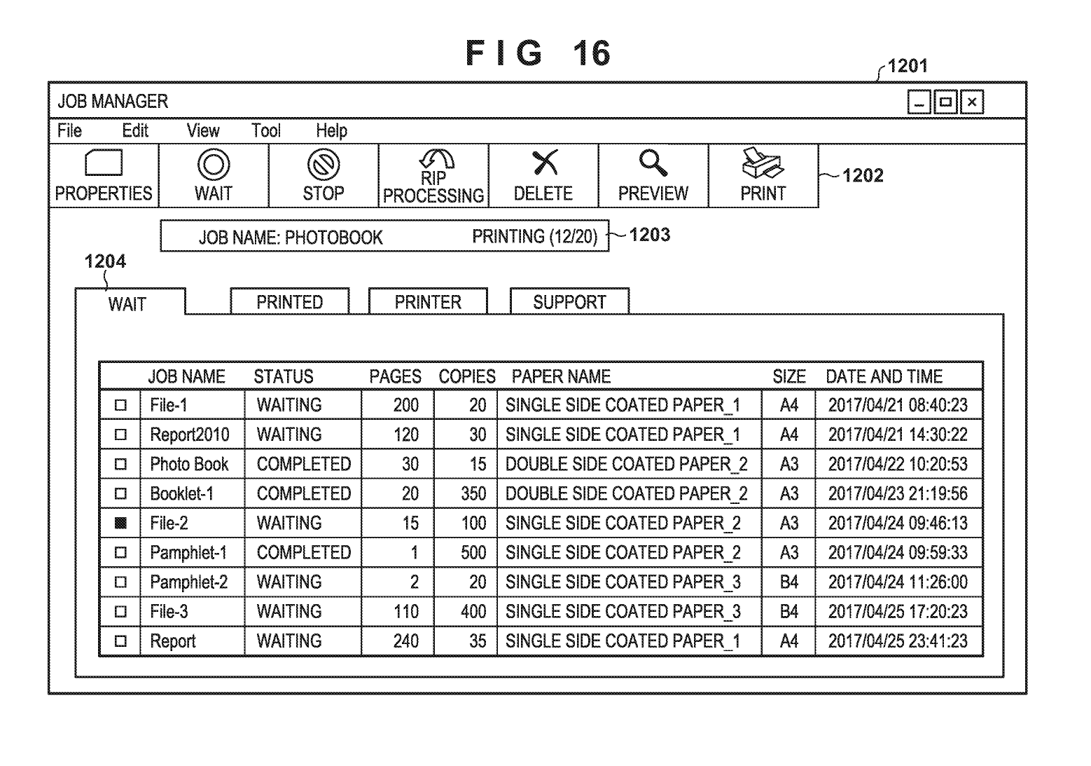

The present embodiment will be described based on the following assumption. It is assumed that there are a plurality of jobs that use “single side coated paper_1” in the wait queue 1204 shown on the screen 1201 of the job manager shown in FIG. 16. Here, as shown in FIG. 16, the plurality of jobs respectively have the following job names: “File-1”, “Report 2010”, and “Report”. Under the circumstances, processing performed when the operator selects “single side coated paper_1” 1109, and presses the edit button 1119 on the paper list screen 1101 shown in FIG. 11 will be described with reference to the flowchart shown in FIG. 15. A program of the control apparatus 102 according to this flowchart is stored in the HDD 309 shown in FIG. 3, and the program is read into the RAM 302, and executed by the CPU 301.

In S1501, the paper management application acquires the paper ID of the paper 1109 in order to look up the paper settings of the paper 1109 selected in the paper list 1102. In S1502, the paper management application searches the wait queue of the job manager for a reserved job that uses a paper that has the same paper ID as the paper ID.

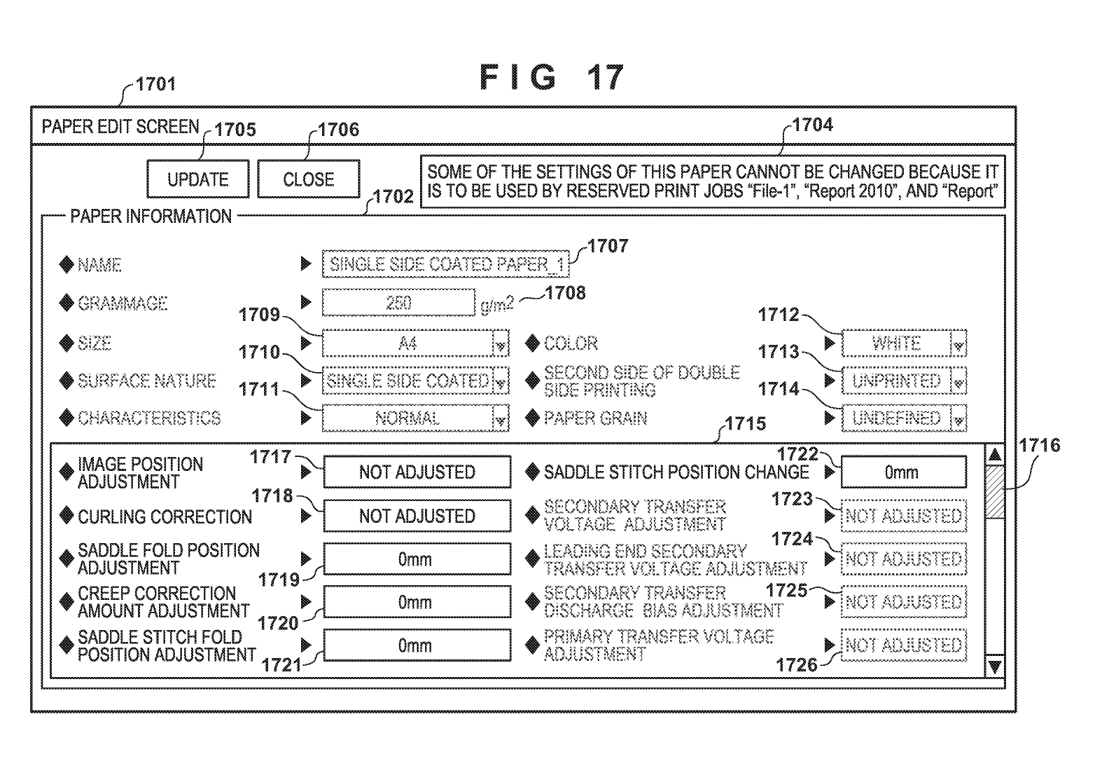

In the present embodiment, as described above, “single side coated paper_1” is used by the reserved jobs “File-1”, “Report 2010”, and “Report” shown in FIG. 16. In this case, as a result of the search processing, the paper management application acquires, as the search result, information indicating that the paper ID indicating “single side coated paper_1” is used by the reserved job. If it is determined that the paper ID is used by a reserved job, the paper management application advances the processing to S1503. In S1503, the paper management application performs control on the screen so as to prohibit (restrict) editing the basic paper setting items as indicated by reference numerals 1707 to 1714 shown in FIG. 17, and the processing transitions to S1504. If, on the other hand, it is determined that the paper ID is used by none of the reserved jobs, the processing transitions to S1506, where the paper management application displays the paper edit screen shown in FIG. 13 without performing any processing, and the flowchart ends.

Next, in S1504, it is checked whether or not the paper ID is used by a plurality of print jobs. In the present embodiment, “single side coated paper_1” is used by the reserved jobs “File-1”, “Report 2010”, and “Report”, and thus the processing advances to S1505. In S1505, the paper management application performs control so as to make print job-dependent setting items uneditable on the paper edit screen. FIG. 17 shows an example of a paper edit screen in which control has been made to make print job-dependent setting items uneditable. The paper management application performs control on the screen so as to prohibit editing the print job-dependent setting items, as indicated by reference numerals 1723 to 1726 shown in FIG. 17. In the settings of the primary transfer voltage and the secondary transfer voltage, an optimal voltage value varies depending on the image rendered on paper, and it is therefore difficult to uniquely determine a set value for a plurality of jobs. Accordingly, in order to prevent such settings from being easily edited by the operator, the print job-dependent setting items are prohibited from being edited. In the present embodiment, the items relating to the primary transfer voltage and the secondary transfer voltage are prohibited from being edited, but the configuration is not limited thereto. If there is an adjustment item that needs to be set individually for a print job, the adjustment item may be prohibited from being edited.

Next, in S1506, the paper management application generates a display message in order to display the reason for having brought the screen into a paper change prohibition state in S1503 and S1505 in a message field 1704 shown in FIG. 17. After that, in S1507, the paper management application displays a paper edit screen including the message generated in S1506 in a display portion, and the processing ends. In the present embodiment, the reason for having made the basic paper setting items unchangeable is displayed together with the job name of the reserved job.

In this way, a setting item that is other than the basic setting items, such as paper size and paper type, of a paper to be used by the reserved job and that is not print job-dependent is allowed to be edited, and it is therefore possible to make adjustment to a portion of the setting items of the paper to be used by the reserved job. In addition, because a setting item that may affect the execution of the reserved job is prohibited from being edited, it is also possible to prevent the problem that printing cannot be performed at the time of executing the reserved job.

### Third Embodiment

Hereinafter, a third embodiment according to the present invention will be described. In the present embodiment, an example will be described in which a reserved job that uses a paper that has the same paper ID as the paper ID selected in the paper list screen 1101 is in a printing state (the job is in progress), with reference to the flowchart shown in FIG. 17.

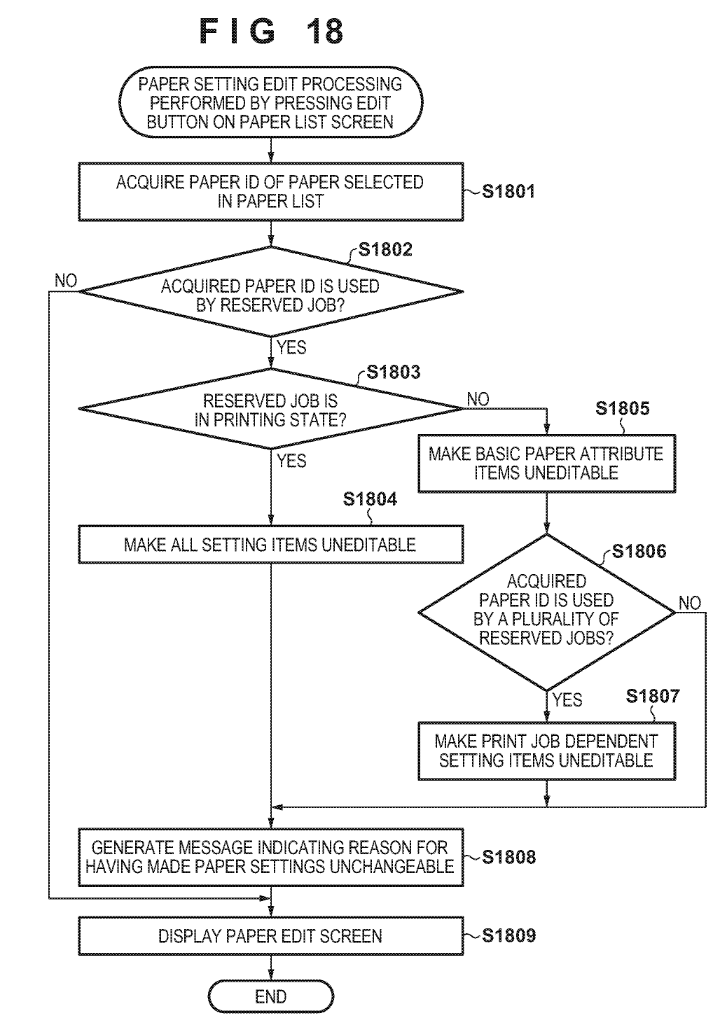

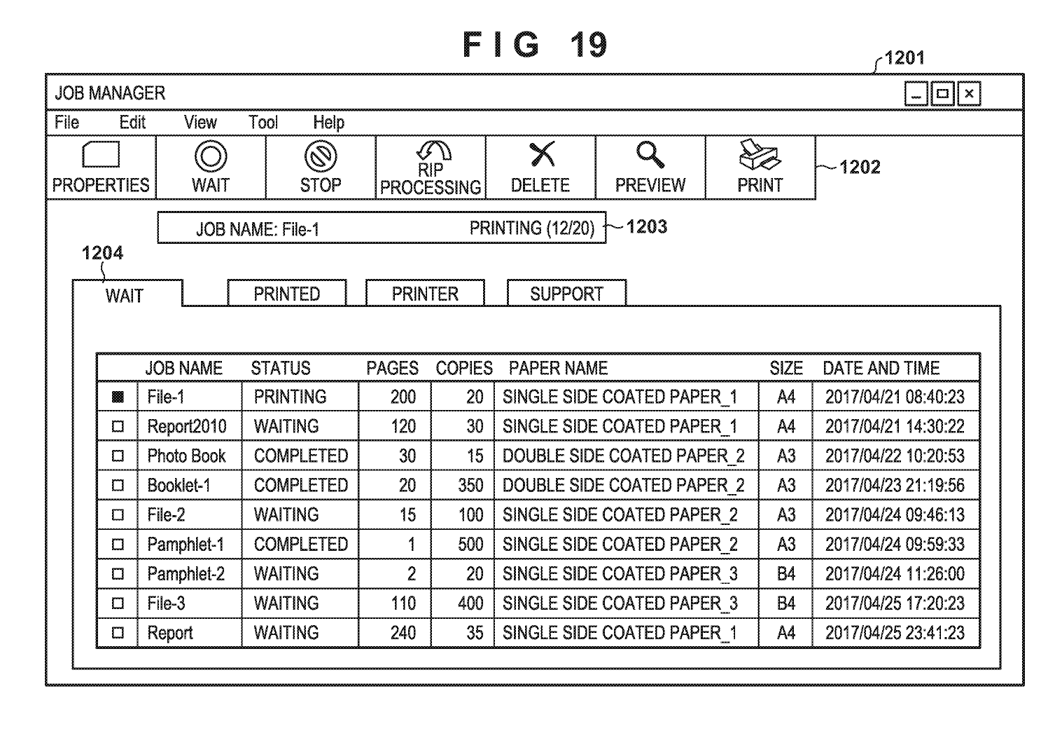

The present embodiment will be described based on the following assumption. As in the second embodiment described above, it is assumed that there are a plurality of jobs that use the paper ID “single side coated paper_1” in the wait queue 1904 of the job manager 1901 shown in FIG. 19. Here, as shown in FIG. 19, the plurality of jobs respectively have the following job names: “File-1”, “Report 2010”, and “Report”. Under the circumstances, when the operator selects “File-1”, and presses a print button 1902, printing of “File-1” starts. Processing performed when the operator selects “single side coated paper_1” 1109, and presses the edit button 1119 on the paper list screen 1101 shown in FIG. 11 during printing of “File-1” will be described with reference to the flowchart shown in FIG. 18. A program of the control apparatus 102 according to this flowchart is stored in the HDD 309 shown in FIG. 3, and the program is read into the RAM 302, and executed by the CPU 301.

In S1801, the paper management application acquires the paper ID of the paper 1109 in order to look up the paper settings of the paper 1109 selected in the paper list 1102. Subsequently, in S1802, the paper management application searches the wait queue of the job manager for a reserved job that uses a paper that has the same paper ID as the paper ID.

In the present embodiment, as described above, “single side coated paper_1” is used by the reserved jobs “File-1”, “Report 2010”, and “Report” shown in FIG. 19. In this case, as a result of the search processing, the paper management application acquires, as the search result, information indicating that the paper ID indicating “single side coated paper_1” is used by the reserved jobs. If it is determined that the paper ID is used by the reserved jobs, the paper management application advances the processing to S1803. If, on the other hand, it is determined that the paper ID is used by none of the reserved jobs, the processing transitions to S1809, where the paper management application displays the paper edit screen shown in FIG. 13 without performing any processing, and the flowchart ends.

In S1803, the paper management application checks whether or not the job that uses a paper having the same paper ID as the found paper ID is in a printing state. In the present embodiment, “File-1” is in a printing state as indicated by reference numeral 1203 in FIG. 19, and thus the processing advances to S1804. If it is determined that the job that uses a paper having the same paper ID as the found paper ID is not in a printing state, the processing advances to S1805. In steps S1805 to S1808, the same processing as that performed in steps S1503 to S1506 according to the second embodiment described above is performed, and thus a description thereof is omitted here.

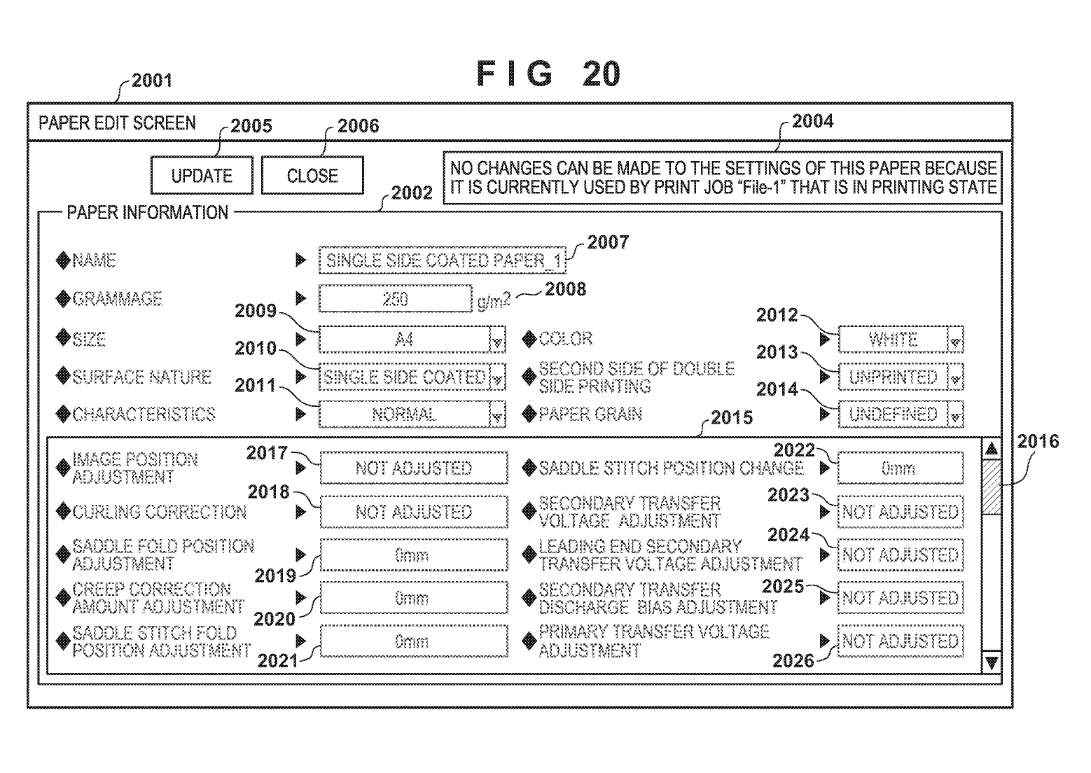

In S1804, as shown in FIG. 20, the paper management application performs control on the screen so as to gray out all setting items other than a close button 2006 and a message field 2004 to make the setting items uneditable. Subsequently, in S1808, the paper management application generates a display message in order to display the reason for having brought the screen into a paper change prohibition state in S1804, S1805, and S1807 in the message field 2004 shown in FIG. 20. After that, in S1809, the paper management application displays a paper edit screen including the message generated in S1808 in the display portion, and the processing ends. In the present embodiment, the message indicates that the job that uses a paper having the same paper ID as the selected paper ID is in a printing state.

In this way, when the job that uses a paper having the same paper ID as the selected paper ID is in a printing state, all paper setting items are prohibited from being edited, and it is therefore possible to prevent a settings change from affecting the job in a printing state. Of course, upon completion of printing the job that uses a paper having the same paper ID as the selected paper ID, the processing returns to the start of the flowchart so as to perform processing, and thereby the screen is updated to a screen similar to that shown in FIG. 17.

In the first to third embodiments described above, examples were described based on the paper edit screen shown in FIG. 13, but it is also possible to perform the same processing on the paper setting screen for sheet feeding stage shown in FIG. 7 that has the similar configuration. In addition, the present embodiment can be implemented in combination with other embodiments of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. and by a method performed by the computer of the system or apparatus by, for example, reading out and

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-133985 filed on Jul. 7, 2017, which is hereby incorporated by reference herein in its entirety.

What is claimed is:

1. A control apparatus that controls an image forming apparatus, the control apparatus comprising:
a memory device that stores a set of instructions; and
at least one processor that executes the set of instructions to:
accept one or more job reservations for the image forming apparatus;
make settings on a plurality of setting items for each paper type of paper used by the image forming apparatus so as to form an image thereon;
in a case where a paper type is selected via the settings, determine whether or not there is a job that uses a paper of the selected paper type in the accepted jobs; and
in a case where it is determined that there is a job that uses a paper of the selected paper type in the accepted jobs, perform control on the selected paper type so as to impose a setting restriction to a portion of the plurality of setting items, and allow settings to be made on another setting items.

2. The control apparatus according to claim 1, wherein
the at least one processor executes instructions in the memory device to:
acquire information regarding the image forming apparatus from the image forming apparatus;
generate a change screen for changing paper settings that are respectively set for a plurality of sheet feeding stages of the image forming apparatus based on the acquired information regarding the image forming apparatus, and accept a user operation via the change screen; and
determine a paper type set for a sheet feeding stage selected by the user operation as a selected paper type.

3. The control apparatus according to claim 2, wherein
the at least one processor executes instructions in the memory device to:
perform control on the change screen so as to gray out a setting item on which a setting restriction is imposed and to not accept a change.

4. The control apparatus according to claim 1, wherein
the at least one processor executes instructions in the memory device to:
in a case where it is determined that there is a job that uses a paper of the selected paper type in the accepted jobs, perform control on the selected paper type so as to impose a setting restriction to a basic paper setting item of the plurality of setting items.

5. The control apparatus according to claim 4, wherein
the basic paper setting item is a setting item relating to all jobs that use the same type of paper.

6. The control apparatus according to claim 4, wherein
the basic paper setting item includes at least the following setting items:
paper name, paper size, paper grammage, and paper surface nature.

7. The control apparatus according to claim 4, wherein
the at least one processor executes instructions in the memory device to:
in a case where it is determined that there are a plurality of jobs that use a paper of the selected paper type in the accepted jobs, for the selected paper type, impose a setting restriction to a setting item that is dependent on each job in addition to the basic setting item.

8. The control apparatus according to claim 4, wherein
the at least one processor executes instructions in the memory device to:
in a case where it is determined that there is a job that uses a paper of the selected paper type in the accepted jobs, further determine whether or not the job is in progress; and
in a case where it is determined that the job is in progress, impose a setting restriction to all setting items of the selected paper type.

9. A control method of controlling a control apparatus that controls an image forming apparatus, the method comprising:
accepting one or more job reservations for the image forming apparatus;
making settings on a plurality of setting items for each paper type of paper used by the image forming apparatus so as to form an image thereon;
in a case where selecting a paper type for which settings are made via a setting unit, determining whether or not there is a job that uses a paper of the selected paper type in the accepted jobs; and
in a case where it is determined in the determining that there is a job that uses a paper of the selected paper type in the jobs accepted in the accepting, performing control on the selected paper type so as to impose a setting restriction to a portion of the plurality of setting items, and allow settings to be made on another setting items.

10. A non-transitory computer-readable storage medium storing a computer program for causing a computer to execute a control method of controlling a control apparatus that controls an image forming apparatus, the method comprising:
accepting one or more job reservations for the image forming apparatus;
making settings on a plurality of setting items for each paper type of paper used by the image forming apparatus so as to form an image thereon;
in a case where selecting a paper type for which settings are made via a setting unit, determining whether or not there is a job that uses a paper of the selected paper type in the accepted jobs; and
in a case where it is determined in the determining that there is a job that uses a paper of the selected paper type in the jobs accepted in the accepting, performing control on the selected paper type so as to impose a setting restriction to a portion of the plurality of setting items, and allow settings to be made on another setting items.

11. An image forming apparatus comprising:
a memory device that stores a set of instructions; and
at least one processor that executes the set of instructions to:
accept one or more job reservations;
make settings on a plurality of setting items for each paper type of paper used so as to form an image thereon;
in a case where a paper type is selected via the settings, determine whether or not there is a job that uses a paper of the selected paper type in the accepted jobs; and
in a case where it is determined that there is a job that uses a paper of the selected paper type in the accepted jobs, perform control on the selected paper type so as to impose a setting restriction to a portion of the plurality of setting items, and allow settings to be made on another setting items.
